(19) United States
(12) Patent Application Publication
(10) Pub. No.: US 2003/0231256 A1
(43) Pub. Date: Dec. 18, 2003

(54) Movable part locking device

(75) Inventors: Makoto Doi, Ishikawa-gun (JP); Ken Ikoma, Yokohama-shi (JP); Tomoyoshi Nakaigawa, Yokohama-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/425,311

(22) Filed: Apr. 29, 2003

(30) Foreign Application Priority Data
Apr. 30, 2002 (JP) P. 2002-128318

(51) Int. Cl. H04N 5/225

(52) U.S. Cl. 348/375

(57) ABSTRACT

A belt whose fixed portion is fixed inside a casing is extended around a tilt stage and passed through a through hole of a fixed plate up to aback face of aback cover. When a lock is released, a fixed portion of the belt is inserted into a releasing hole thereby to create a gap between an abutted portion of the belt and a lock part 11c of the tilt stage, and the tilt stage will be made free to rotate. When the tilt stage is locked, the fixed portion is inserted into a locking hole, and the abutted portion of the belt will be pulled to be abutted against the lock part, thereby to hold the tilt stage.

### BACKGROUND OF THE INVENTION

1. Field of the Invention

The present invention relates to a protective mechanism in an appliance such as an image pickup apparatus, particularly, to a movable part locking device which is adapted to lock a movable part of the appliance in order to protect such precision appliances from vibrations or shocks during transportation.

2. Description of the Related Art

There has been known a movable part locking device for protecting precision appliances such as an image pickup apparatus from vibrations or shocks during transportation so as to prevent the appliance from being damaged. Such movable part locking device has been used, for example, in an iris image pickup apparatus to be employed in security systems. The iris image pickup apparatus includes a wide angle camera for picking up an image of a subject in a wide range, and a telephoto camera for picking up a enlarged image of the iris of the subject. Identification of individuals can be operated by the iris images picked up by the telephoto camera. The applicant has proposed the iris image pickup apparatuses, for example, in U.S. appl. Ser. No. 10/149,884 filed on Jun. 14, 2002 and so on.

The telephoto camera mounted with a tilt stage of the iris image pickup apparatus, especially, in which valuable components such as the camera is included, may sometimes be broken, since the tilt stage rotates by vibrations or shocks during transportation. In order to prevent the tilt stage from rotating, a lock mechanism, for example, for indirectly braking a shaft of the tilt stage as a movable part by a screw which can be accessed from an exterior, thereby to hold and fix the tilt stage, is provided.

However, the lock mechanism as described above has a problem that the screw is positioned in a deep part of the mechanism to see from the front, and hence a locked condition of the tilt stage can be easily confirmed from the exterior. It has another problem that it is difficult to determine whether or not the pivotal shaft is reliably braked and the tilt stage is locked because there are individual differences in screwing torque when the pivotal shaft of the tilt stage is locked. Further, it has another problem it is necessary to take countermeasures as like providing a mechanism for preventing slack of the screw in order to maintain the locked condition in a stabilized state over time. However, the countermeasure incurs high cost by increasing the number of components.

### SUMMARY OF THE INVENTION

The object of the invention is to provide a movable part locking device which can simply and reliably hold the movable part such as a tilt stage mounted with a telephoto camera by employing a few components, in an appliance such as an image pickup apparatus.

Another object of the invention is to provide the movable part locking device in which a locked state and a released state can be easily confirmed from the exterior.

The invention provides a movable part locking device for locking a movable part contained in a casing, comprises flexible belt means, one end of which is fixed to a determined position inside the casing, and first belt securing means for securing another end of the flexible belt means to a first determined position outside the casing, wherein the flexible belt means is abutted against at least a portion of a periphery of the movable part, and secured the another end of the flexible belt means to the first belt securing means after passing through a first hole formed at a determined position of the casing, thereby to lock the movable part.

According to the above-described structure, the flexible belt means is abutted against the periphery of the movable part of an precision appliance such as the image pickup apparatus, and the another end of the flexible belt means is secured. As the results, the movable part can be locked and reliably held.

Moreover, the movable part locking device further comprises second belt securing means for securing the another end of the flexible belt means to a second determined position outside the casing, wherein the flexible belt means is secured the another end of the flexible belt means to the second belt securing means after passing through the first hole of the casing, thereby to release the movable part which was locked.

According to the above-described structure, the flexible belt means presses the movable part to lock it, when the another end of the flexible belt means is secured to the first securing means, and the flexible belt means releases the movable part to make it free, when the another end of the flexible belt means is secured to the second securing means. Therefore, an operator can easily determine at a glance over a secured position of the flexible belt means whether the movable part is in the locked condition or in the released condition.

Further, the flexible belt means has a plurality of joint portions enabling the flexible belt means to be bent.

According to the above-described structure, bending condition can be restricted according to the position of the flexible belt means to be abutted against the movable part. Therefore, when the movable part is released, the flexible belt means can retreat to a position at which the belt means does not interfere with the movable part, and when the movable part is locked, the flexible belt means can reliably hold the movable part.

Still further, each of the joint portions is shaped to restrict a bending angle in a bending direction, and that a bending repulsive force is created due to this shape, when the flexible belt means is bent at the joint portions.

According to the above-described structure, the flexible belt means can be bent at a determined angle in a determined direction. Therefore, it is possible to make the belt means to reliably retreat and make the movable part free to rotate, when the movable part has been released from the locked state.

Still further, each of the first and second belt securing means is formed by hole in a convex shape, and when the another end of the flexible belt means is inserted into the hole, the another end of the flexible belt means is expanded by the bending repulsive force to be fixed in the hole.

According to the above-described structure, the belt means can be secured by simply bending the end of the belt means and inserting it in the hole of the casing in a convex shape. Therefore, the movable part locking device can be composed of a few components, and at the same time, operability become enhanced.

Still further, the flexible belt means partly has a notch portion, and the casing partly has first guide means for the flexible belt means, wherein the first guide means guides the flexible belt means by way of the notch portion, when the another end of the flexible belt means is secured to the first belt securing means or the second belt securing means.

According to the above-described structure, at the locking operation or the lock releasing operation of the movable part, a displacement of the flexible belt means in a lateral direction can be prevented. Therefore, the movable part can be reliably locked or released.

Still further, the first belt securing means is provided at such a position as the flexible belt means protrudes from an exterior plane of the casing in a state that the flexible belt means is secured to the first belt securing means, and the second belt securing means is provided at such a position as the flexible belt means is located inside the exterior plane of the casing in a state that the flexible belt means is secured to the second belt securing means.

According to the above-described structure, when the casing which contains the movable part is mounted on a wall face or the like with using a casing mounting means, in case that the movable part is locked, an appliance constructed with the movable part and the casing will be unable to be assembled to the casing mounting means, since the flexible belt means which protrudes interferes with the casing mounting means. Therefore, it is possible to prevent the appliance from being fitted to the casing mounting means while the movable part is locked, by mistake.

Still further, the casing has a second hole which is formed at a position to be blocked by the flexible belt means when the flexible belt means has been secured to the first belt securing means, casing mounting means on which the casing is mounted has protruded means which is adapted to be engaged with the second hole of the casing.

According to the above-described structure, when the casing which contains the movable part is mounted on the wall face or the like with using the casing mounting means, in case that the movable part is locked, the appliance will be unable to be assembled to the casing mounting means, since the protruded part of the casing mounting means is abutted against the flexible belt means. Therefore, it is possible to prevent the appliance from being fitted to the casing mounting means while the movable part is locked, by mistake.

Still further, the movable part is a tilt stage of an image pickup apparatus.

According to the above-described structure, the flexible belt means is abutted against a periphery of the tilt stage of the image pickup apparatus, and the another end of the flexible belt means is secured. Therefore, it is possible to lock and reliably hold the tilt stage which is the movable part, and the appliance such as a telephoto camera which is mounted on the tilt stage can be prevented from being damaged.

Still further, the first belt securing means is positioned in the same direction as the tilt stage, and the second belt securing means is positioned in an opposite direction to the tilt stage.

According to the above-described structure, when the tilt stage is locked, because the belt means is abutted against the tilt stage along its periphery to exert a force, it is possible to reliably lock the tilt stage. When the lock is released to use the image pickup apparatus, the flexible belt means is separated from the periphery of the tilt stage, and the tilt stage can be reliably made free to rotate.

Still further, the flexible belt means has at least a fixed portion to be fixed to the casing, an abutted portion to be abutted against a side face of the tilt stage, a shift portion which is straightened when the flexible belt means secures to the first belt securing means and bent when the flexible belt means secures to the second belt securing means, and a fixed portion to be secured to the first and second belt securing means.

According to the above-described structure, because the belt means is abutted against the tilt stage always in the same condition, stability of the tilt stage in the locked condition become enhanced.

Still further the casing has second guide means for the flexible belt means extending from the first hole toward the interior of the casing.

According to the above-described structure, even though the flexible belt means is forced to be inserted into the casing when the tilt stage become locked or released, movement of the flexible belt means is restricted by the second guide means, and operability become enhanced.

### BRIEF DESCRIPTION OF THE DRAWINGS

FIG. 1 is a front view showing a structure of an iris image pickup apparatus provided with a movable part locking device according to a first and a second embodiments of the present invention;

FIG. 2 is an exploded perspective view showing a structure of the movable part locking device according to a first embodiment of the invention;

FIG. 3A is a plan view of the belt of the first embodiment;

FIG. 3B is a side view of the belt of the first embodiment;

FIGS. 4A, 4B and 4C are a sectional view showing shapes of joint portions of the belt according to the first embodiment of the invention;

FIG. 5A is a sectional view showing lock-released state of the movable part locking device of the first embodiment;

FIG. 5B is a sectional view showing locked state of the movable part locking device of the first embodiment;

FIG. 6A is a plain view of the belt of a second embodiment;

FIG. 6B is a side view of the belt of a second embodiment;

FIG. 7 is a perspective view showing a structure of a back cover according to the second embodiment of the invention;

FIG. 8A is a sectional view showing lock-released state of the movable part locking device of the second embodiment;

FIG. 8B is a sectional view showing locked state of the movable part locking device of the second embodiment.

### DETAILED DESCRIPTION OF THE PREFERRED EMBODIMENTS

In the following embodiments, an iris image pickup apparatus is explained as the appliance to which a movable part locking device of the invention is preferably applied. The following explains a structural example of the iris image pickup apparatus.

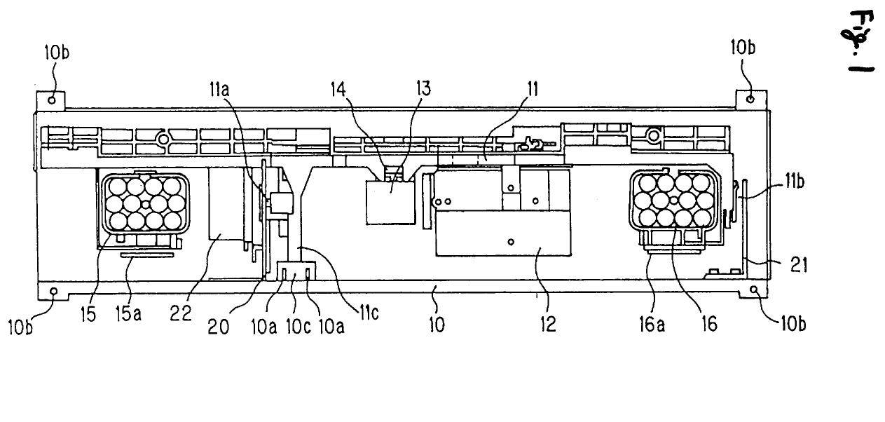

FIG. 1 is a front view showing a structure of the iris image pickup apparatus including the movable part locking device of a first and a second embodiments. The iris image pickup apparatus includes a fixed plate 10 formed in a shape of an elongated box. In a leftward bottom part of the fixed plate 10, a guide part 10a for guiding a belt which constitutes the movable part locking device of the invention is uprightly provided as described below. At a back side in a lower area of the fixed plate 10, a through hole 10c for passing the belt through is formed. In addition, in small planes formed by bending four corners of the fixed plate 10 outwardly at right angles in an L-shape, fitting holes 10b for fitting the iris image pickup apparatus to a casing described below.

In the bottom part of the fixed plate 10, support plates 20, 21 are uprightly provided, on which a tilt stage 11 having shafts 11a, 11b at both ends is rotatablly supported. A tilt motor 22 is mounted to the support plate 20. A rotation axis of the tilt motor 22 is connected to one of the shafts 11a of the tilt stage 11.

A telephoto camera 12 for picking up an iris image, a panning mirror 13 which converts an optical axis of the iris image, a panning motor 14 which drives the panning mirror 13, and illuminating units 15, 16 for the telephoto camera are mounted with the tilt stage 11. The illuminating units 15, 16 for the telephoto camera are equipped with light condensing lenses to condense infrared light on an iris of an object person to be recognized, and panning motors 15a, 16a to set direction of the luminous light to the iris. In a leftward lower part of the tilt stage 11, a lock part 11c adapted to be abutted against the belt, which constitutes the movable part locking device as described below, is provided.

The following explains the movable part locking device of each embodiment.

(First Embodiment)

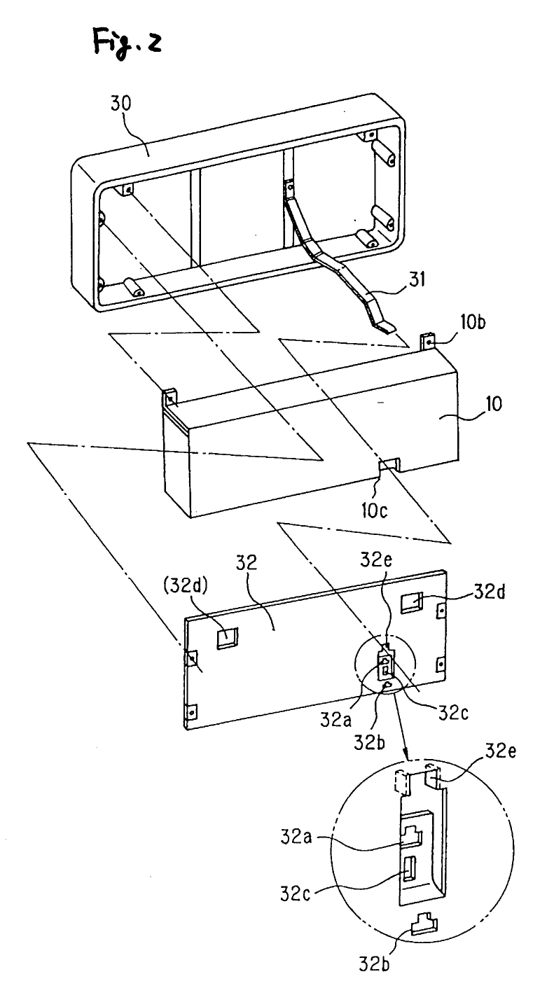

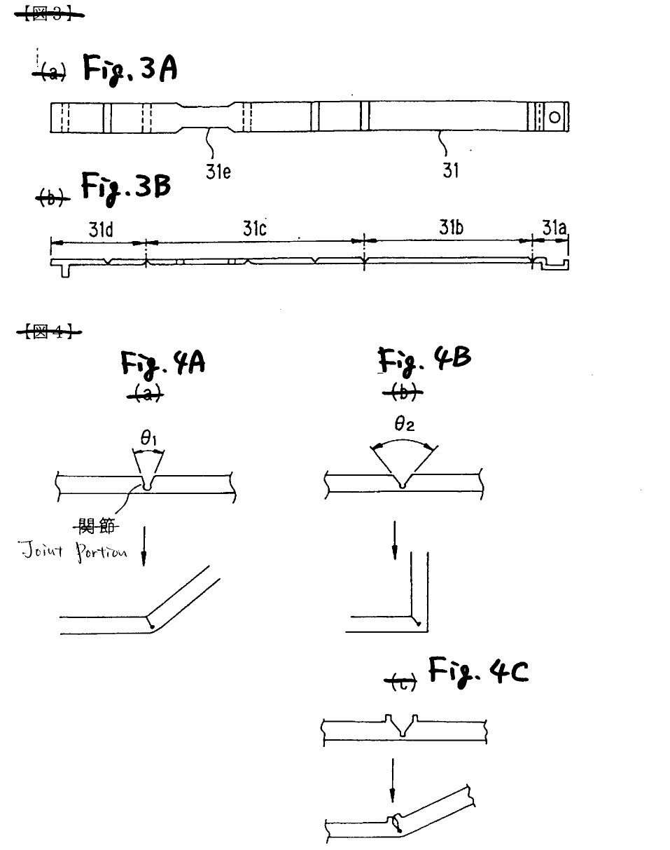

FIG. 2 is an exploded perspective view showing a structure of the movable part locking device of a first embodiment. FIG. 3A is a plan view of the belt of the first embodiment. FIG. 3B is a side view of the belt of the first embodiment. FIGS. 4A, 4B and 4C are a sectional view showing shapes of joint portions of the belt of the first embodiment. FIG. 5A is a sectional view showing lock-released state of the movable part locking device of the first embodiment. FIG. 5B is a sectional view showing locked state of the movable part locking device of the first embodiment.

As shown in FIG. 2, the fixed plate 10 mounted with the iris image pickup apparatus is contained inside a casing 30 and fixed by screws through the fitting holes 10b. One end of a belt 31 is fixed to an inner back face of the casing 30 at a determined position. The other end of the belt 31 is passed through the through hole 10c of the fixed plate 10 and extended to a back side of the fixed plate 10.

A back cover 32 for covering the fixed plate 10 to contain the iris image pickup apparatus is fitted to the casing 30. The back cover 32 has a releasing hole 32a in convex shape for securing the other end of the belt 31 on a face erected backward by cutting from a portion of its rightward lower part, and a detecting hole 32c for detecting a mounting hardware described below. A locking hole 32b on the same plane as the back cover 32 and in the same shape as the releasing hole 32a is provided underneath the releasing hole 32a and the detecting hole 32c. Mounting holes 32d for mounting the casing 30 to the mounting hardware described below, and a guide part 32e adapted to be engaged with the through hole 10c of the fixed plate 10 thereby to guide the belt 31 so as not to be inserted in an upward direction by mistake are further provided with the back cover 32.

The casing 30 and the back cover 32 are installed on a wall face by employing a mounting hardware 33 as shown in FIGS. 5A and 5B. The mounting hardware 33 has a protruded part 33a adapted to be engaged with the detecting hole 32c when the casing 30 is mounted, and hooks 33b to be hooked with the mounting holes 32d.

Referring to FIGS. 3A, 3B, 4A, 4B and 4C, the following explains the belt 31 which constitutes an essential part of the movable part locking device for the precision appliance.

As shown in FIGS. 3A and 3B, the belt 31 is made of resin having flexibility, for example. The belt 31 is formed of a fixed portion 31a fixed to the casing 30, an abutted portion 31b abutted against a side face of the tilt stage 11, a shift portion 31c which is bent when the tilt stage 11 has been locked and straightened when the lock has been released, a fixed portion 31d fixed to the back cover 32, and joint portions respectively connecting these portions.

A shape of the abutted portion 31b is determined in a manner that a contact angle with the lock part 11c of the tilt stage 11 and moving directions of the belt 31 may not be large. The shift portion 31c is provided with a notch 31e engaged with the guide part 10 provided on the fixed plate 10 so as to guide the belt 31.

The fixed portion 31d has structure for exerting a force in a direction expanding outwardly at its terminal end by bending 90 degrees like a crest at the joint portion, and thereafter bending 180 degrees like a trough. When the fixed portion 31d in a state bended like a trough has been inserted into a wider area of the convex-shaped hole of either the releasing hole 32a or the locking hole 32b, the fixed portion 31d is caught by a narrow area of the convex-shaped hole of the releasing hole 32a or the locking hole 32b with a repulsive force of the belt 31 which is recovering to the original state. Therefore, the fixed portion 31d is not be disengaged.

Further, each of the joint portions connecting the respective portions has a recess in a shape of an inverted triangle, as shown in FIGS. 4A and 4B in an enlarged scale. Open angle are determined θ1 or θ2 to be able to restrict a direction and an angle in which the belt 31 is bent. Small projections may be provided at edges of the recess as shown in FIG. 4C, so that a repulsive force may be generated at the joint portion when the belt has been bended.

On occasion of using the belt 31, the fixed portion 31a is fixed to the casing 30 by a screw or the like, the abutted portion 31b extends around a lower part of the lock part 11c of the tilt stage 11, the shift portion 31c engages with the guide part 10a of the fixed plate 10, and the fixed portion 31d passes through the through hole 10c of the fixed plate 10 to be exposed out of the back face of the back cover 32, and fixed in the releasing hole 32a or the locking hole 32b.

The following, referring to FIGS. 5A and 5B, explains operation of the movable part locking device of the first embodiment having the above-described structure. FIG. 5A is a sectional view showing state that the lock of the tilt stage 11 which is the movable part has been released. FIG. 5B is a sectional view showing state that the tilt stage 11 is locked.

To release the tilt stage 11 which is locked as shown in FIG. 5B, an operator, at first, pushes the fixed portion 31d of the belt 31 with a finger. As a result, the fixed portion 31d restores to the original state by a repulsive force and fixes in the releasing hole 32a. At this time, since the force is exerted in a direction that the belt 31 shifts toward a front face side of the casing 30as a whole, the belt 31 is guided along the guide part 10a by way of the through hole 10c so as to slide in a forward direction. Accordingly, the abutted portion 31b shifts toward a front face side of the casing 30. Therefore, there will be created a gap between the lock part 11c of the tilt stage 11 and the abutted portion 31b, and the tilt stage 11 become free to rotate.

To lock the tilt stage 11 which is released as shown in FIG. 5A, the operator disengages the fixed portion 31d of the belt 31 from the releasing hole 32a, and pulls toward the back face side of the back cover 32. Then, the shift portion 31c which was straightened is also pulled backward, and guided by the guide part 10a so as to slide in a backward direction. As the abutted portion 31b of the belt 31 is also pulled backward, either of the faces of the lock part 11c is abutted against the abutted portion 31b, irrespective of the condition of the tilt stage 11. When an operator further pulls the belt 31, the guide part 10a strikes a sectional face of the notch 31e of the shift portion 31c to function as a stopper.

Then, the operator bends the joint portion in the shift portion 31c of the belt 31 to an outside of the back cover 32. Thereafter, the operator collapses the fixed portion 31d insert into the locking hole 32b to make free. Then, the fixed portion 31d is restored to the original state with the repulsive force and fixed in the locking hole 32b. On this occasion, since the lock part 11c of the tilt stage 11 and the abutted portion 31b are in tight contact with each other, the tilt stage 11 become unable to rotate in a downwardly inclined fixed state.

The following, referring to FIGS. 5A and 5B, explains operation of installing the casing 30 containing the iris image pickup apparatus to the mounting hardware 33 which was mounted on a wall. As described before, the mounting hardware 33 has the protruded part 33a protruded in an opposite direction to the wall face, and the two hooks 33b in the upper part.

In the state that the tilt stage 11 is released by the belt 31 as shown in FIG. 5A, an operator presses the casing 30 against the wall face, while position of the protruded part 33a of the mounting hardware 33 with respect to the detecting hole 32c of the back cover 32, and position of the hooks 33b with respect to the mounting holes 32d are respectively aligned. Thereafter, the operator slides the casing 30 downward, then, the hooks 33b of the mounting hardware 33 come into engagement with the mounting holes 32d of the back cover 32 to secure the casing 30.

On the other hand, in the state that the tilt stage 11 is locked by the belt 31 as shown in FIG. 5B, the detecting hole 32c of the back cover 32 is blocked with the belt 31 as described before. Therefore, even though an operator try to mount the casing 30 on the mounting hardware 33, the operator cannot insert the protruded part 33a of the mounting hardware 33 into the detecting hole 32c. Thus, the operator can quickly learn that the tilt stage 11 is locked. The camera appliances such as the iris image pickup apparatus are essentially unable to perform their function, unless the lock of the tilt stage 11 is released. Consequently, it is possible to effectively prevent the apparatus from being mounted on the mounting hardware 33 without releasing the lock, by mistake.

Such function can be also performed by providing the fixed portion 31 of the belt 31 or other means, for example, a screw, so as to project outwardly from the back cover 32 when the tilt stage 11 is locked. On the other hand, The function can be also performed by providing the fixed portion 31d of the belt 31 or a head of the screw so as to be positioned inside a face of the back cover 32 when the lock of the tilt stage is released.

In the state that the tilt stage 11 is released by the belt 31 as shown in FIG. 5A, when the operator tries to mount the casing 30 to the mounting hardware 33, there is no obstacle for mounting the casing 30 to the mounting hardware 33. The reason is that the fixed portion 31d of the belt 31 is inserted into the releasing hole 32a positioned inside the face of the back cover 32.

On the other hand, in a state that the tilt stage 11 is locked by the belt 31 as shown in FIG. 5B, even if the operator tries to mount the casing 30 to the mounting hardware 33, the fixed portion 31d will protrude out of the face of the back cover 32 and come into abutment against the mounting hardware 33. The reason is that the fixed portion 31d of the belt 31 or the head of the screw is inserted into the locking hole 32b which is on the same plane as the back cover 32. Accordingly, the casing 30 is unable to be mounted on the mounting hardware 33, thus, it is possible to prevent the apparatus from being mounted on the mounting hardware 33, without releasing the lock of the movable part such as the tilt stage 11, by mistake.

In the case that the operator forcibly tries to push the belt 31 deep into the casing 30 by mistake, the shift portion 31c of the belt 31 is pushed upwardly from the through hole 10c of the fixed plate 10. After the shift portion 31c has been pushed in to a certain extent, the shift portion 31c comes into contact with the guide part 32e which is usually not in a position to touch with the belt 31, and prevented from being further inserted. Therefore, the belt 31 does not disturb the rotation of the tilt stage 11 inside the casing 30.

As described above, the tilt stage 11 of the iris image pickup apparatus can be reliably held and locked, by abutting the belt 31 fixed at its one end to the casing 30 against the lock part 11c constituting a part of the tilt stage 11, and further, by inserting the other end of the belt 31 into the locking hole 32b of the back cover 32.

Moreover, when the other end of the belt 31 is disengaged from the locking hole 32b and inserted into the releasing hole 32a, the tilt stage 11 become free to rotate. Therefore, the operator can easily know whether the tilt stage 11 as a movable part is in the locked state or in the released state, at a glance over the position where the belt 31 is inserted.

Further, because the other end of the belt 31 is fixed to the back cover 32 at different positions depending on the occasion when the tilt stage 11 has been locked or released, it is be possible to prevent the apparatus from being mounted on the mounting hardware 33, without releasing the lock, by mistake.

Still further, because the back cover 32 is independent of the fixed plate 10, the through hole 10c of the fixed plate 10 can be made sufficiently large to incorporate the guide part 32e provided on the back cover 32 behind the through hole 10c. Accordingly, the belt 31 can be easily passed close to the locking hole 32b, and operability enhances.

(Second Embodiment)

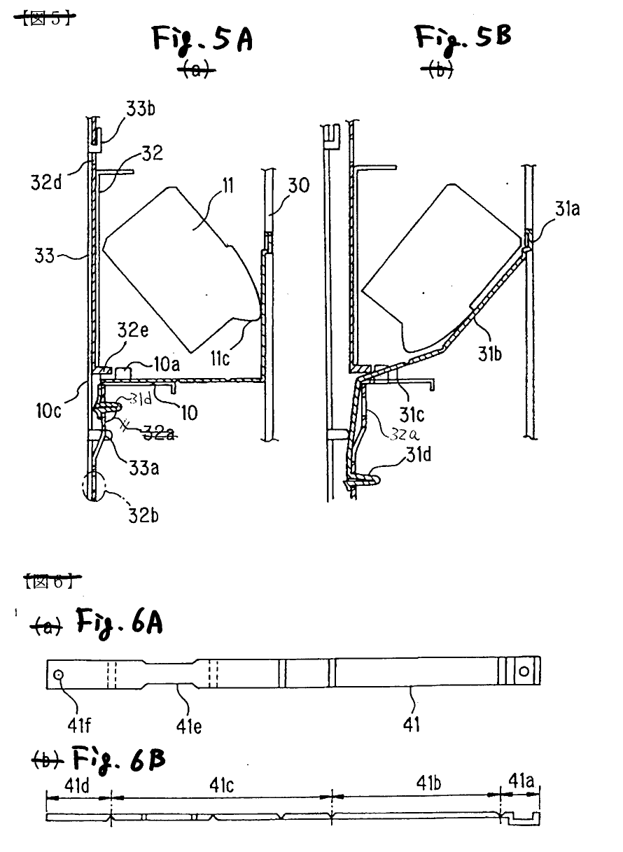

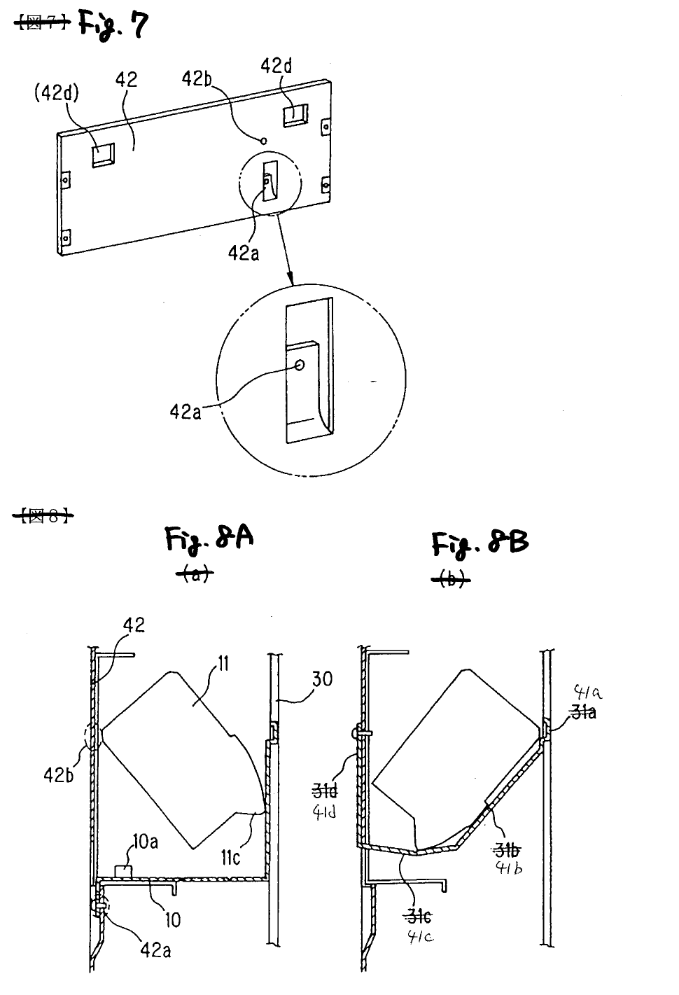

FIG. 6A is a plain view of the belt of a second embodiment. FIG. 6B is a side view of the belt of a second embodiment. FIG. 7 is a perspective view showing a structure of the back cover of the second embodiment. FIG. 8A is a sectional view showing lock-released state of the movable part locking device of the second embodiment. FIG. 8B is a sectional view showing locked state of the movable part locking device of the second embodiment.

The second embodiment is not different in function from the first embodiment. However, the other end 31d of the belt 31 is fixed by means of a screw in the second embodiment, which can be preferably applied to a case in which there is a space behind the back cover. The second embodiment is described hereunder, referring to FIG. 6A to FIG. 8B. It is to be noted that the components which are common with those components in FIGS. 2, 3A, 3B, 5A and 5B will be denoted with same reference numerals, and their explanation is omitted.

FIGS. 6A and 6B are structural view showing a shape of the belt for locking the tilt stage 11 to be employed in this embodiment, which are different from FIGS. 3A and 3B in the shape of the fixed portion. The belt 41 is made of resin, for example, having flexibility. The belt 41 is constructed to have a fixed portion 41a fixed to the casing 30, an abutted portion 41b abutted against a side face of the tilt stage 11, a shift portion 41c which is bent when the tilt stage 11 has been locked and straightened when the lock has been released, a fixed portion 41d having at its end a round hole 41f to be fixed to the back cover 42, and joint portions respectively connecting these portions.

As shown in FIG. 7, the back cover 42 has a face erected backward by cutting from a portion of its rightward lower part, which is provided with a releasing hole 42a formed with screw hole for fixing the fixed portion 41d of the belt 41, which will be described below, when the lock of the tilt stage 11 is released. Above the releasing hole 42a, there is further provided a locking hole 42b formed with screw hole for fixing the fixed portion 41d of the belt 41, which will be described below, when the tilt stage 11 is locked.

Referring to FIGS. 8A and 8B, the following explains operation of the movable part locking device according to the second embodiment having the above described structure. FIGS. 8A and 8B are view showing the mode of operation of the movable part locking device. FIG. 8A shows a state that the lock of the tilt stage 11 as the movable part has been released. FIG. 8B shows a state that the tilt stage 11 is locked.

To release the tilt stage 11 which is locked as shown in FIG. 8B, an operator secures by a screw the fixed portion 41d of the belt 41 into the releasing hole 42a of the back cover 42 through the round hole 41f. Following this movement, a forwardly pushing force is exerted on the belt 41, and the shift portion 41c is expanded. In the same manner as described in the first embodiment, there will be created a gap between the lock part 11c of the tilt stage 11 and the abutted portion 41b, and the tilt stage 11 become free to rotate.

To lock the tilt stage 11 which is unlocked as shown in FIG. 8A, the operator disengages the screw which secured the fixed portion 41d of the belt 41 from the releasing hole 42a, and pulls to the back face side of the back cover 42. With this motion, the shift portion 41c and the abutted portion 41b are also pulled backward. As the results, the lock part 11c of the tilt stage 11 comes into abutment against the abutted portion 41b.

Then, the operator upwardly bends the joint portion in the shift portion 41c of the belt 41 to an outside of the back cover 42. Thereafter, the operator secures by the screw the fixed portion 41d of the belt 41 in the locking hole 42b through the round hole 41f. On this occasion, since the lock part 11c of the tilt stage 11 and the abutted portion 41b are in tight contact with each other, the tilt stage 11 become unable to rotate in a downwardly inclined fixed state.

As described above, when the tilt stage 11 has been locked, the screw is projected outward of the back cover 42. Accordingly, the casing 30 is unable to be mounted on the mounting hardware 33. On the other hand, when the tilt stage 11 which was locked has been released, the belt 41 is secured to the face which is erected by cutting inwardly of the back cover 42, and the screw head sinks inside the back face of the back cover 42. As the results, the casing 30 can be mounted on the mounting hardware 33 without a problem. In this manner, the operator can easily recognize that the tilt stage 11 is locked.

It is to be noted that although the illuminating units 15, 16 for the telephoto cameras are mounted on the tilt stage 11 in the above described embodiments, substantially the same operation and effects as in the above described embodiments can be obtained, even in case that they are arranged outside. It is also possible to omit the panning mirror 13 and the panning motor 14 which drives the panning mirror 13, and to render the telephoto camera 12 to directly pan.

Moreover, although it is so constructed that the notch in the shift portion 31c (41c) of the belt 31 (41) is clamped by the two upright guide parts 10a of the fixed plate 10 so as to be guided, it is possible to form an elongated hole in a middle of the shift portion 31c (41c) so as to guide the belt by a single guide part 10a.

Further, although these embodiments have been so far described referring to the tilt stage of the iris image pickup apparatus as an example of the movable part of the precision appliance, the invention can be widely applied to apparatuses such as the precision appliance having the movable member contained in a casing.

What is claimed is:

1. A movable part locking device for locking a movable part contained in a casing, comprising:
flexible belt means, one end of which is fixed to a determined position inside the casing, and
first belt securing means for securing another end of the flexible belt means to a first determined position outside the casing,
wherein the flexible belt means is abutted against at least a portion of a periphery of the movable part, and secured the another end of the flexible belt means to the first belt securing means after passing through a first hole formed at a determined position of the casing, thereby to lock the movable part.

2. A movable part locking device according to claim 1, further comprising:
second belt securing means for securing the another end of the flexible belt means to a second determined position outside the casing,
wherein the flexible belt means is secured the another end of the flexible belt means to the second belt securing means after passing through the first hole of the casing, thereby to release the movable part which was locked.

3. A movable part locking device according to claim 1,
wherein the flexible belt means has a plurality of joint portions enabling the flexible belt means to be bent.

4. A movable part locking device according to claim 3,
wherein each of the joint portions is shaped to restrict a bending angle in a bending direction, and that a bending repulsive force is created due to this shape, when the flexible belt means is bent at the joint portions.

5. A movable part locking device according to claim 4,
wherein each of the first and second belt securing means is formed by hole in a convex shape, and when the another end of the flexible belt means is inserted into the hole, the another end of the flexible belt means is expanded by the bending repulsive force to be fixed in the hole.

6. A movable part locking device according to claim 1,
wherein the flexible belt means partly has a notch portion, and the casing partly has first guide means for the flexible belt means,
wherein the first guide means guides the flexible belt means by way of the notch portion, when the another end of the flexible belt means is secured to the first belt securing means or the second belt securing means.

7. A movable part locking device according to claim 1,
wherein the first belt securing means is provided at such a position as the flexible belt means protrudes from an exterior plane of the casing in a state that the flexible belt means is secured to the first belt securing means, and
the second belt securing means is provided at such a position as the flexible belt means is located inside the exterior plane of the casing in a state that the flexible belt means is secured to the second belt securing means.

8. A movable part locking device according to claim 1,
wherein the casing has a second hole which is formed at a position to be blocked by the flexible belt means when the flexible belt means has been secured to the first belt securing means,
casing mounting means on which the casing is mounted has protruded means which is adapted to be engaged with the second hole of the casing.

9. A movable part locking device according to claim 1,
wherein the movable part is a tilt stage of an image pickup apparatus.

10. A movable part locking device according to claim 9,
wherein the first belt securing means is positioned in the same direction as the tilt stage, and the second belt securing means is positioned in an opposite direction to the tilt stage.

11. A movable part locking device according to claim 9,
wherein the flexible belt means has at least a fixed portion to be fixed to the casing, an abutted portion to be abutted against a side face of the tilt stage, a shift portion which is straightened when the flexible belt means secures to the first belt securing means and bent when the flexible belt means secures to the second belt securing means, and a fixed portion to be secured to the first and second belt securing means.

12. A movable part locking device according to claim 9,
wherein the casing has second guide means for the flexible belt means extending from the first hole toward the interior of the casing.
